(19) United States
(12) Patent Application Publication
(10) Pub. No.: US 2011/0208597 A1
(43) Pub. Date: Aug. 25, 2011

(54) NETWORKED BASED MODULARIZED ADVERTISEMENTS

(75) Inventor: Abhishek Kumar, Bangalore (IN)

(73) Assignee: Yahoo! Inc, Sunnyvale, CA (US)

(21) Appl. No.: 12/711,565

(22) Filed: Feb. 24, 2010

(51) Int. Cl. G06Q 30/00; G06F 3/048

(52) U.S. Cl. 705/14.72; 705/14.73; 715/862

(57) ABSTRACT

A system for serving localized advertisements generates browser code operable by a browser to cause the browser to display a web page of information that includes an advertisement. The displayed advertisement includes a graphical indicator that indicates that the advertisement is associated with an interface for conveying additional information associated with the advertisement. The advertisement and the additional information are submitted during an advertisement submission time. The browser code is also operable by the browser to cause the browser to detect a selection of the graphical indicator and display the interface along with the information displayed on the web page in response to the selection of the graphical indicator.

### BACKGROUND

The Internet has emerged as a powerful advertising tool. It is commonplace to see advertisements on many web sites. For example, advertisements may be displayed on search web sites and may be targeted to individuals based upon search terms provided by the individuals. Other web sites, such as news and sports web sites, may provide space for advertisements. The owners of these web sites may sell advertising space to advertisers to offset the costs associated with operating the web sites as well as to turn a profit.

One problem with advertising via search web sites, however, is that in order to be effective, these web sites must generate a high number of non-advertisement-based search results. This in turn limits the amount of real estate available for advertisements, which in turn limits the message that may be conveyed by a given advertisement.

### BRIEF DESCRIPTION OF THE DRAWINGS

FIG. 1 illustrates a system for submitting and serving advertisements;

FIG. 2 illustrates an exemplary search web page that may be communicated by a search server of the system of FIG. 1;

FIG. 3 is an exemplary advertisement submission web page that may be communicated to an advertiser by an advertisement submission server of the system of FIG. 1;

FIG. 4a illustrates an exemplary search web page that displays an interactive interface;

FIG. 4b illustrates an exemplary search web page that displays an experience interface;

FIG. 4c illustrates an exemplary search web page that displays an integrated interface 415;

FIG. 5 illustrates a group of operations that may be performed by the system 100 of FIG. 1;

FIG. 6 illustrates a group of operations that may be performed by a browser receiving a result web page from the system of FIG. 1;

FIG. 7 illustrates a group of operations that may be performed by the system of FIG. 1 when receiving an advertisement submission; and

FIG. 8 illustrates a general computer system, which may represent any of the computing devices referenced herein.

### DETAILED DESCRIPTION

The embodiments below describe an exemplary embodiment of a system for serving advertisements. Generally, the system is configured to generate a search result web page with advertisements that includes browser code for generating a selectable pop-up interface that conveys additional information about a selected advertisement. The system is also configured to provide an interface that enables an advertiser to submit an advertisement to the system and to select and specify an interface to be associated with the advertisement.

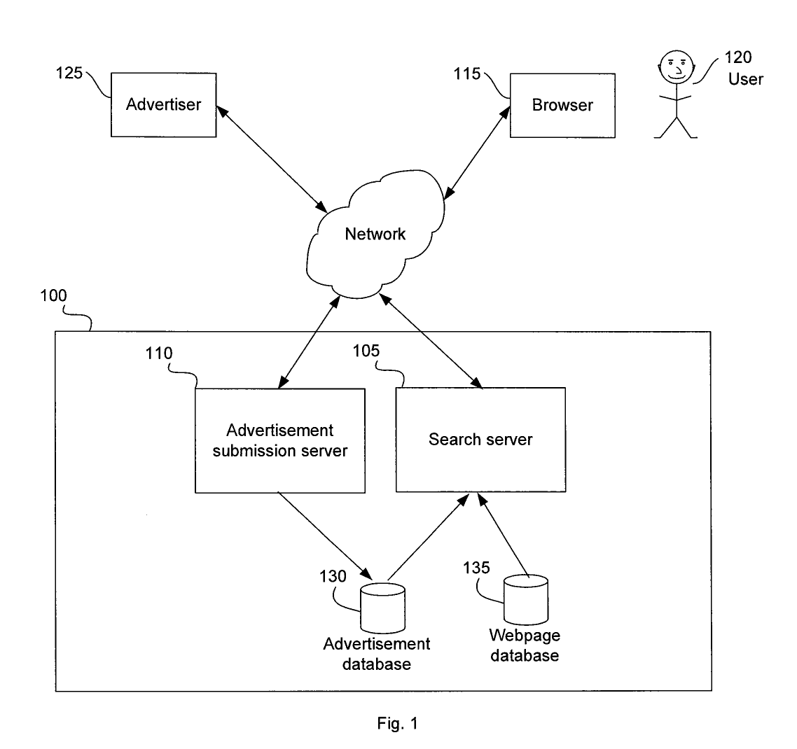

FIG. 1 is a system 100 for submitting and serving advertisements. The system 100 includes a search server 105, an advertisement submission server 110, an advertisement database 130, and a web page database 135. The various components of the system 100 may reside on a single computer or be distributed among several computers interconnected by a communication network.

The search server 105 and advertisement submission server 110 may correspond to an Intel®, AMD®, or PowerPC® based computer or a different computer. The search server 105 and advertisement submission server 110 may include an operating system, such as a Microsoft Windows®, Linux, or other Unix® based operating system. The search server 105 and advertisement submission server 110 may be configured to communicate with other computers via an interface, such as a network interface.

The search server 105 may include code, logic, and/or other circuitry that enables the reception of a request to serve a key word search web page, such as a Yahoo!® search page, to a user's browser 115, and to communicate a web page with the results of the key word search to the user's browser 115. The results include links to web pages and advertisements that are associated with the key word.

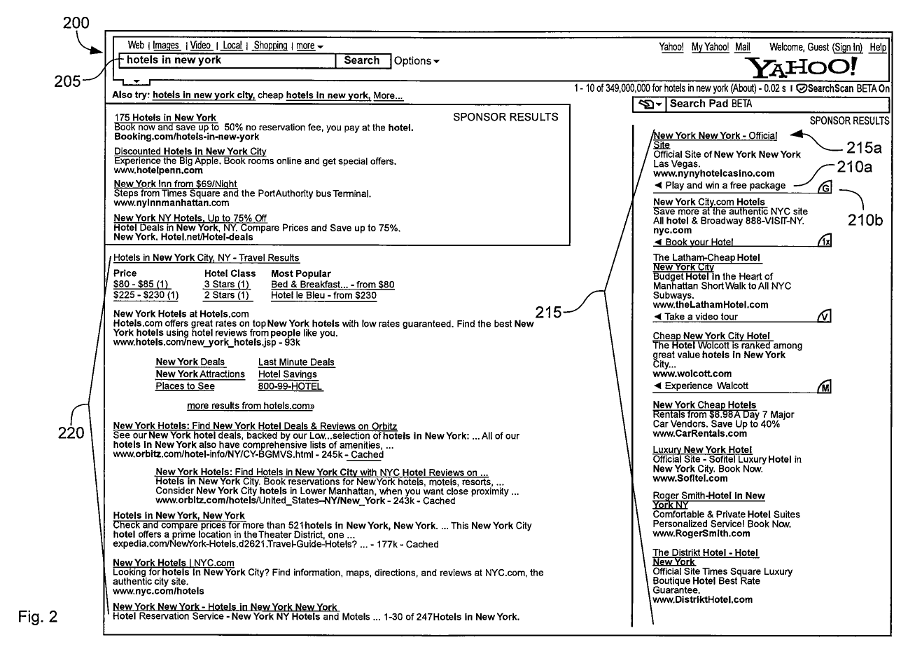

FIG. 2 illustrates an exemplary search web page 200 that may be communicated by the search server 105. The exemplary search web page 200 includes a search term field 205 that is utilized to enter a key word to be searched. The web page 200 also displays search results. The search results include web page links 220 that are links to web pages that are associated with the key word. The search results also include advertisements 215 that are associated with the key word. The advertisements 215 may have been previously associated with a given key word via, for example, an online competitive bidding process. Commonly owned U.S. Pat. No. 6,269,361 illustrates one system in which advertisers may bid on key words to position advertisements among search results presented to a searcher.

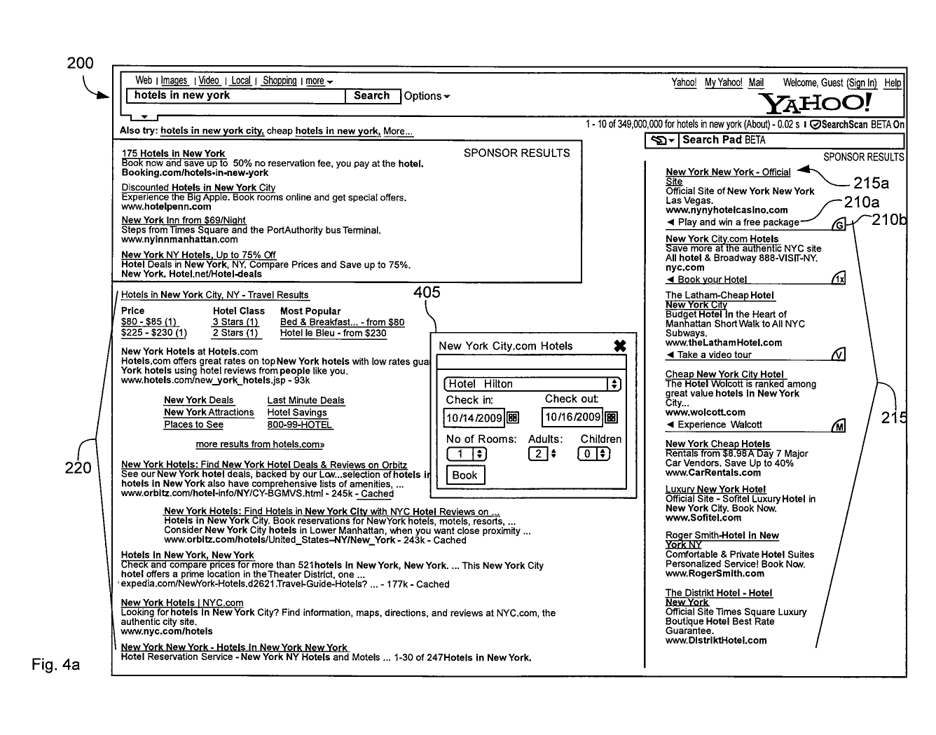

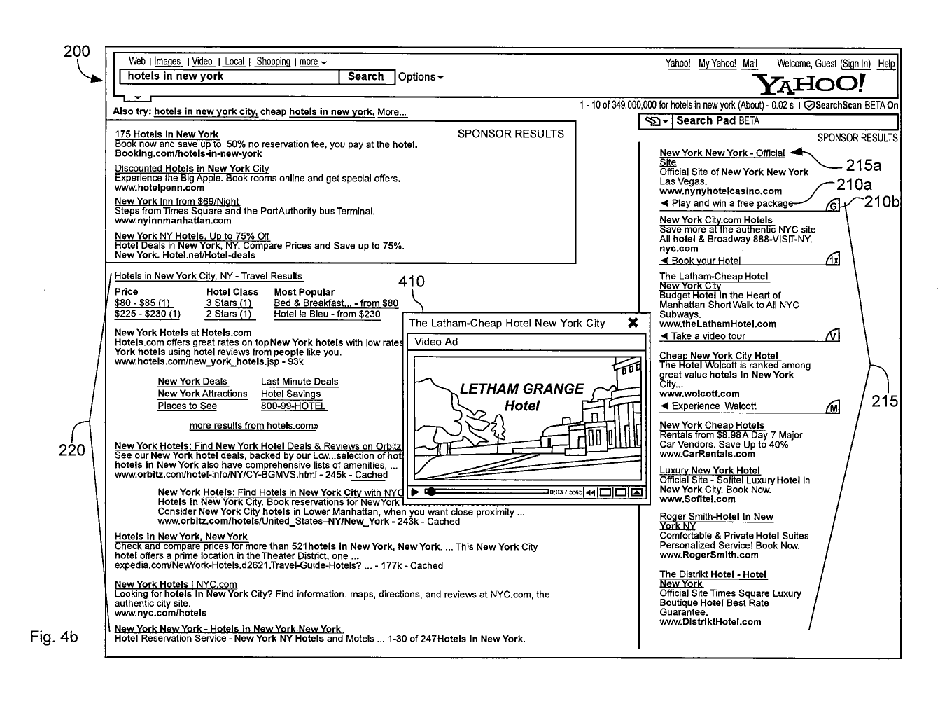

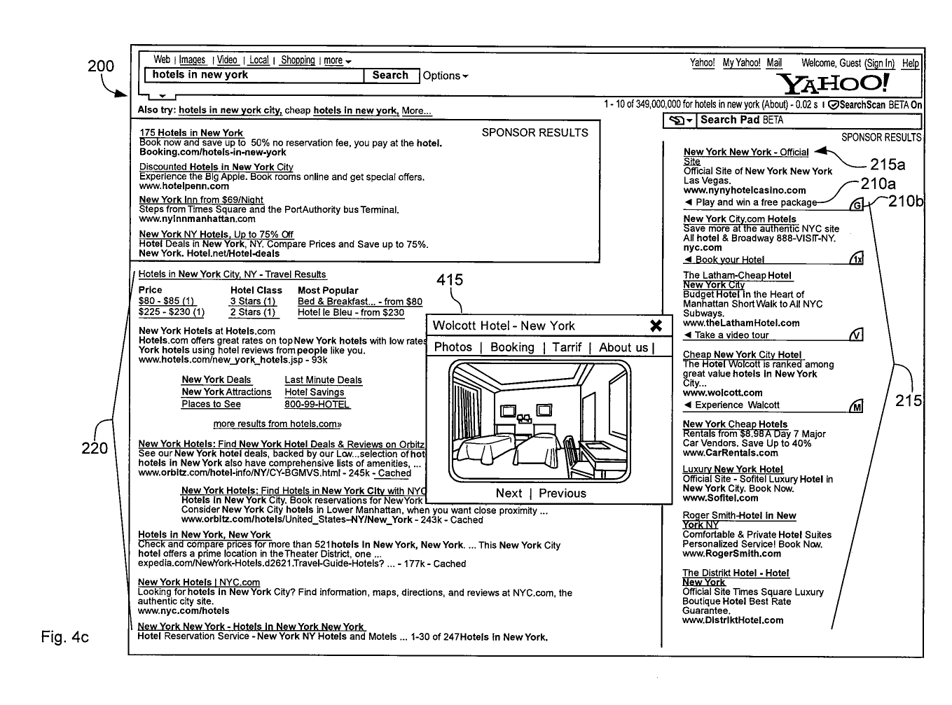

To facilitate the display of the web page 200, the web page 200 may comprise browser code, such as hyper text markup language (HTML), Sun Microsystems, Inc. Java®, Microsoft Corp. Visual Basic® script, Adobe Systems Inc. Flash®, or other code, that is executed by a browser to cause the browser to display the search results. The browser code may also include code operable to cause the browser to display various interfaces configured to convey additional information associated with a given advertisement. Exemplary interfaces are shown in FIGS. 4a-4c, which are discussed in more detail below.

Advertisements associated with an interface may include an interface indicator 210a and 210b. The interface indicator 210a and 210b may be a graphic indicator 210b and/or a text indicator 210a. The interface indicator 210a and 210b is utilized to indicate to a user that a given advertisement has a corresponding interface that may provide additional information about the advertisement.

The browser code may be operable to display the interface when a selection of a given advertisement is detected. For example, the interface may be displayed when a user clicks on an advertisement with a pointing device, such as a mouse, light pen or different point device. The interface may be displayed when the user positions a cursor over or near the advertisement. For example, dragging a cursor across the advertisement may cause an interface associated with the advertisement to be displayed. In some implementations, the interface is displayed when a user clicks or otherwise moves a cursor over the interface indicator 210a and 210b of a given advertisement.

Referring back to FIG. 1, the advertisement submission server 110 may include code, logic, and/or other circuitry that enables submitting an advertisement with the system 100. To facilitate submission of the advertisement, the advertisement submission server 110 may be operative to generate an advertisement submission web page that enables an advertiser 125 to specify information that defines a given advertisement.

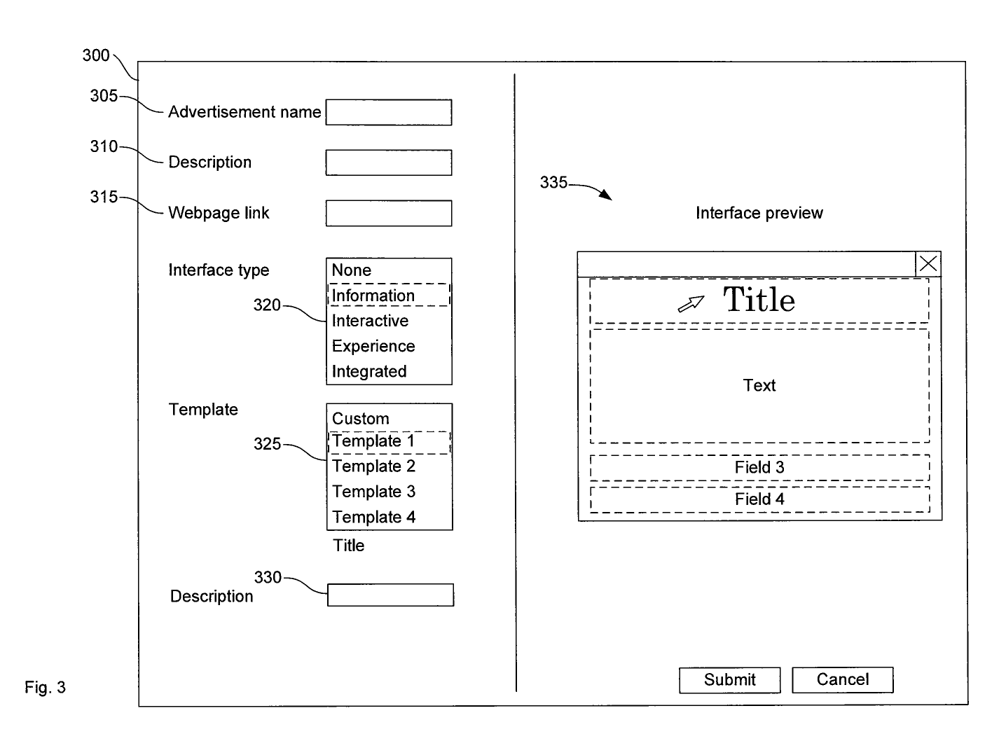

FIG. 3 is an exemplary advertisement submission web page 300 that may be communicated to an advertiser 125 (FIG. 1) by the advertisement submission server 110 of FIG. 1. The exemplary advertisement submission web page 300 includes various fields and other items that may be implemented on a single web page, as shown, or distributed among a number of web pages. Although certain fields and/or items are shown, it is to be understood that other fields and items may also be included.

The exemplary advertisement submission web page 300 includes an advertisement name field 305, an advertisement description field 310, and a web page link field 315 that enable the advertiser 125 to specify the advertisement name, description, and web page link, respectively, associated with an advertisement. For example, referring to the exemplary advertisement 215a of FIG. 2, the advertisement name may correspond to the text “New York N.Y.—Official Site.” The description may correspond to the text “Official Site of New York N.Y. Las Vegas.” The link may correspond to the text “www.nynyhotelcasino.com.”

The exemplary advertisement submission web page 300 also includes fields that enable associating an interface with a given advertisement. The fields include an interface type field 320, a template field 325, and a description field 330. The interface type field 320 enables specifying a type of interface, if any, to be associated with the advertisement. For example, the interface type may correspond to an information interface, an interactive interface, an experience interface, or an integrated interface, all of which are described below. Interfaces are utilized by an advertiser to convey additional information associated with an advertisement that cannot otherwise be associated with the advertisement given the limited web page real estate that is typically provided on a search web page for a given advertisement. In some implementations, advertiser's pay a premium to have an interface associated with an advertisement. In yet other implementations, the type of interface displayed or the complexity of the interface may affect the cost associated with the interface. For example, an advertiser may pay a premium for an interactive interface.

An information interface is utilized to communicate static information, such as an image or text. For example, an information interface may be utilized to provide contact information associated with a hotel that is the subject of an advertisement. The information interface may be utilized to provide a brief description of the hotel and/or other information.

An interactive interface is configured to receive input from a user and to process the input to produce a result. FIG. 4a depicts a search web page 200 (FIG. 2) with an exemplary interactive interface 405. The exemplary interactive interface 405 is configured to allow a user to book a room at a hotel. To enable this functionality, the interactive interface 405 includes fields for providing the dates of stay at the hotel, the number of rooms, etc. The interactive interface 405 may be controlled with code, such as hyper text markup language (HTML), Sun Microsystems, Inc. Java®, Microsoft Corp. Visual Basic® script, Adobe Systems Inc. Flash®, or other code, that controls the functionality of the interactive interface 405. For example, code associated with the exemplary interactive interface 405 of FIG. 4a may be operative to verify dates of stay entered by a user, communicate the dates to a hotel reservation server (not shown), and to communicate output received from the hotel reservation server.

An experience interface is configured to provide a user with an audio and/or visual experience associated with an advertisement. FIG. 4b depicts a search web page 200 (FIG. 2) with an exemplary experience interface 410 that conveys a video of a hotel that is the subject of the selected advertisement.

An integrated interface is an interface that combines the features of the other interfaces described above. FIG. 4c depicts a search web page 200 (FIG. 2) with an exemplary integrated interface 415. The exemplary integrated interface 415 includes a set of tabs that enable the user to view the different types of interfaces associated with the selected advertisement. For example, a “photo” tab may correspond to an experience interface that displays photos of a hotel that is the subject of the selected advertisement. A “booking” tab may correspond to an interactive interface configured to enable a user to book a room at the hotel that is the subject of the advertisement. An “About us” tab may correspond to an information tab that provides general information about the hotel that is the subject of the selected advertisement.

Referring back to FIG. 3, the template field 325 enables an advertiser to select a pre-configured template of the selected interface type. The template may define standard behaviors associated with a given interface. For example, a first interactive interface template may be configured to enable booking rooms at a hotel. The first interactive interface template may define input fields and other fields that enable a user to provide information associated with the booking of a hotel room, such as date fields for specifying the dates of stay at the hotel.

In some implementations, the template field 325 enables selecting a custom interface. Upon selecting a custom interface selection of the template field 325, the advertiser may be presented with one or more additional input fields (not shown) for specifying and uploading data that defines a custom interface. For example, an advertiser may upload a custom interface that defines a game. In addition, interfaces developed by third parties may be specified in the same way. For example, upon selecting the custom interface selection of the template field 325, the advertiser may be presented with a list of interfaces developed by third parties.

In some implementations, an interface preview 335 associated with the selected interface type and template is displayed in the advertisement submission web page 300. The interface preview 335 enables an advertiser to preview and customize a selected interface template. For example, the advertiser may select a title region of the interface template and replace the text of the title with a more suitable title. Other information may be specified. For example, a user may select various input fields of an interface preview 335 associated with an interactive interface template and may specify various attributes that control the behavior of the input fields, such as a default value, a minimum value, and a maximum value. Other attributes may also be specified.

An interface preview 335 associated with an experience interface template may enable an advertiser to upload visual and audio information to be conveyed via the experience interface. For example, an input field for specifying data files that define audio information, such as MP3, way, etc., to be uploaded via the advertisement submission web page and associated with the experience interface associated with a given advertisements may be provided. Video data files, such as MPEG2, MPEG4, or a different video data file, may be uploaded and associated with the experience interface. In some implementations, a link to a server with audio and/or video information to be conveyed may be provided. In this case, the audio and/or video information may be streamed or otherwise communicated to an experience interface when the experience interface is served to a user. This enables an advertiser to change the audio and/or video information associated with an experience interface without having to access the advertisement submission web page 300.

The description field 330 enables an advertiser to specify a description associated with an interface. In some implementations, the text specified in the description field 330 corresponds to the text indicator 210a (FIG. 2) associated with an advertisement.

The advertisement submission web page 300 is configured to store the information associated with a given advertisement to the advertisement database 130 (FIG. 1) or a different database. The advertisement database 135 may include information that defines a given advertisement. For example, data that defines the content of an advertisement, such as pixel data and/or text data, may be stored in the database 135. Data that defines the geographic location of an advertiser 130 associated with the advertisement may also stored in the advertisement database 135. For example, the data may include the address of the advertiser 130, a closest intersection to the advertiser 130, a latitude and longitude of the advertiser 130, and/or other information that enables determining the geographic location of the advertiser 130.

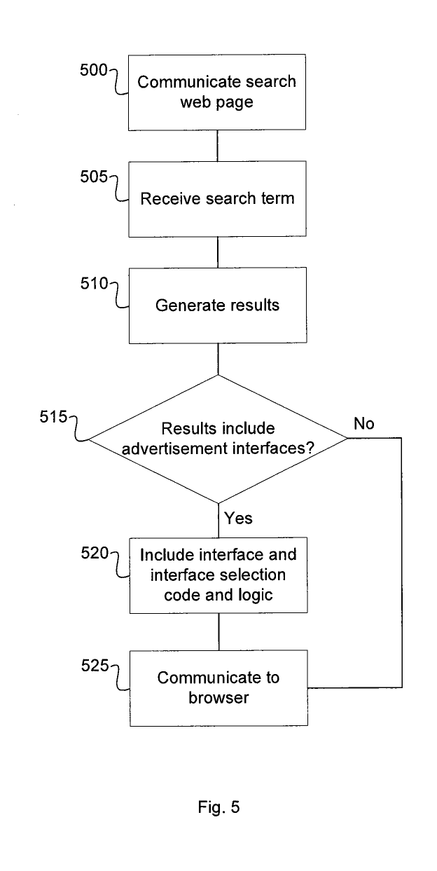

FIG. 5 illustrates a group of operations that may be performed by the system 100 (FIG. 1). At block 500, a search web page may be communicated. For example, the search server 105 (FIG. 1) may communicate the exemplary search web page 200 to a browser 115 (FIG. 1).

At block 505, search terms may be received. For example, a user 120 (FIG. 1) may specify search terms in the search term field 205 of the exemplary search web page 200. The search terms may then be submitted to the search server 105.

At block 510, a result list may be generated by the search server 105. The results may include links to web pages that comprise text associated with the search term and also advertisements that are associated with the search term.

At block 515, the result list is analyzed by the search server 105 or a different server to determine whether any of the advertisements are associated with interfaces. If at block 515, some of the advertisements are associated with the interface, then at block 520, code and logic that is operable to display the interface is inserted by the search server 105 into the data that defines the result web page. The code and logic may include HTML code, Java® code, a scripting code, Flash® code, or other code suitable for causing an interface, such as any of the interfaces described above, to be displayed in a browser.

At block 525, the result page is communicated to the browser 115. For example, the search server 105 may communicate the result page.

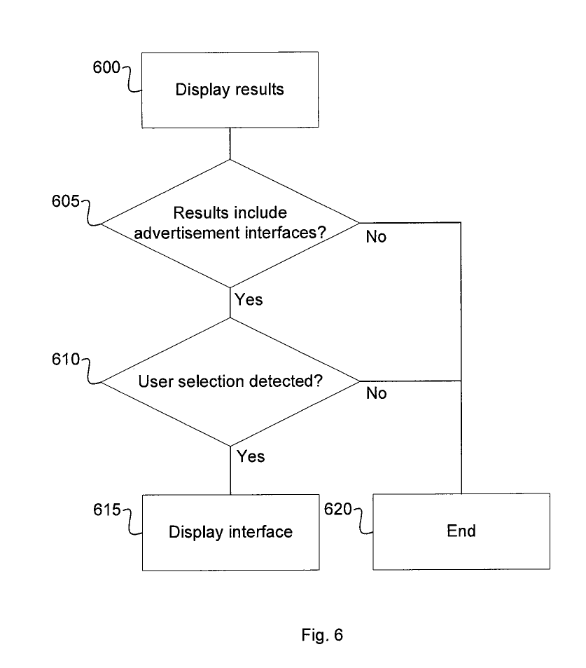

FIG. 6 illustrates a group of operations that may be performed by a browser receiving a result web page from the system 100. At block 600, the display results communicated at block 525 above, may be displayed in a browser. For example, the results shown in exemplary search result page 200 (FIG. 2) may be displayed in the browser 115 (FIG. 1).

At block 605, if the results include advertisements with interfaces, then if at block 610 a user selection of an advertisement interface is detected by the browser, then at block 615, the interface is displayed. For example, if the user clicks on an interface indicator 210a and 210b (FIG. 2) or moves a cursor over the interface indicator 210a and 210b, an interface may be displayed by the browser along with the results of the exemplary search web page 200. The interface may correspond to an information, interactive 405 (FIG. 4a), experience 410 (FIG. 4b), or integrated interface 415 (FIG. 4c) as described above. The interface may correspond to a different interface or a custom interface specified by an advertiser.

If at block 605 none of the advertisements include an interface, or if at block 610, the user does not select an advertisement, the operations may end at block 620.

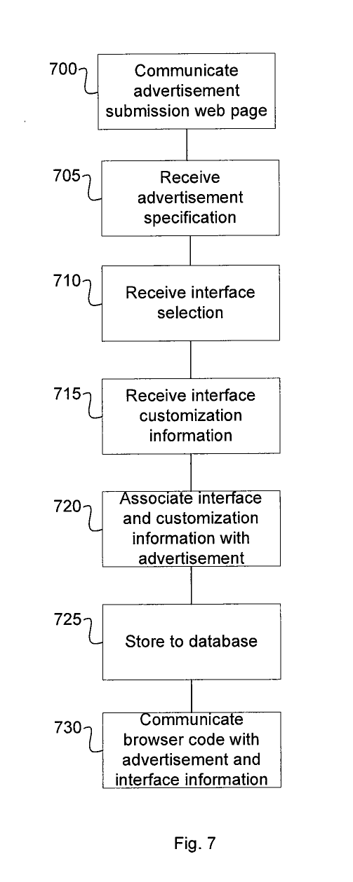

FIG. 7 illustrates a group of operations that may be performed by the system 100 (FIG. 1) when receiving an advertisement submission. At block 700, an advertisement submission web page 300 (FIG. 3) may be communicated to an advertiser 125 (FIG. 1) by, for example, the advertisement submission server 110 (FIG. 1) or a different server.

At block 705, the advertisement may be specified via the advertisement submission web page 300 (FIG. 3). For example, an advertisement name, description, and web page link may be specified via an advertisement name field 305 (FIG. 3), an advertisement description field 310 (FIG. 3), and a web page link field 315 (FIG. 3), respectively.

At block 710, a selection of an interface type may be received. For example, a user may select one of the enumerated interface types in an interface type field 320 (FIG. 3). The selection may indicate a general type of interface to be associated with the advertisement. For example, the interface may correspond to an information, interactive, experience, and/or integrated interface, as described above. The selection information may be communicated to the advertisement submission server 110.

At block 715, customization information for customizing the selected interface may be received. For example, a preconfigured template of one of the above-identified interfaces may be selected via a template field 325 (FIG. 3). An interface preview 335 (FIG. 3) of the selected template may be shown on the advertisement submission web page 300. The advertisement submission web page 300 may be operative to allow an advertiser to select customizable fields of the template shown in the interface preview 335 and to enable the advertiser to specify the text or other information to be added in place of the default field values.

The customizable information that may be specified may depend on the type of interface and/or the selected template. For example, audio and video files for display in an experience interface may be uploaded and associated with an experience interface template. Text information or static images may be uploaded and associated with an information interface template.

In some implementations, a custom interface template may be created. The advertisement submission web page 300 may be operable to receive data that defines the custom interface template. For example, scripting code that defines an interface, such as a FLASH® file, may be uploaded and associated with the advertisement. The scripting code may be included in the code that defines a search result web page. This gives an advertiser maximum flexibility in the type of interface desired by, for example, enabling the advertiser to control the look-n-feel, interface structure, and interactivity of the custom interface. For example, the advertiser may upload a custom interface that defines a game. Interfaces with these features may not exist in the library of interface templates.

The scripting code may be operable to receive input from input fields, process data entered into the input fields, and to provide a result to a user. The scripting code may also be operable to communicate results or data entered by the user to a server (not shown) that is configured to process the information. For example, a user may enter desired booking dates for a hotel via an interactive interface and submit the desired dates. Code that operates the interface may be operable to communicate the desired date to a server configured to book rooms at the hotel. The server may then communicate the dates that are available back to the interface, which may then display the results to the user. This advantageously enables the user to quickly specify information without the need for leaving the search result page.

At block 720, the selected interface and the customization information that defines the interface may be associated with the advertisement and stored to a database, such as the advertisement database 130 of FIG. 1, by the advertisement submission server 110 or a different server.

At block 730, the advertisement and code operable to generate an associated interface may be communicated to a browser as part of a search result list.

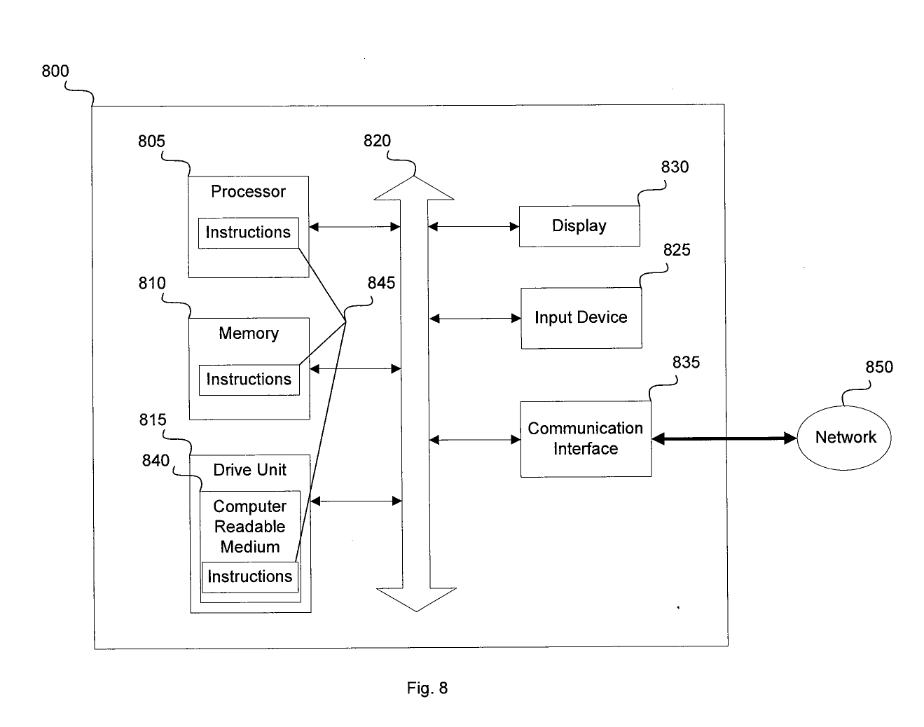

FIG. 8 illustrates a general computer system 800, which may represent the advertisement submission server 110, the search server 105, the user browser 115, or any other computing devices referenced herein. The computer system 800 may include a set of instructions 845 that may be executed to cause the computer system 800 to perform any one or more of the methods or computer-based functions disclosed herein. The computer system 800 may operate as a stand-alone device or may be connected, e.g., using a network, to other computer systems or peripheral devices.

In a networked deployment, the computer system 800 may operate in the capacity of a server or as a client-user computer in a server-client user network environment, or as a peer computer system in a peer-to-peer (or distributed) network environment. The computer system 800 may also be implemented as or incorporated into various devices, such as a personal computer or a mobile device, capable of executing a set of instructions 845 (sequential or otherwise) that specify actions to be taken by that machine. Further, each of the systems described may include any collection of sub-systems that individually or jointly execute a set, or multiple sets, of instructions to perform one or more computer functions.

The computer system 800 may include a memory 810 on a bus for communicating information. The advertisement database 130 (FIG. 1) and/or the web page database 135 (FIG. 1) may be stored in the memory 810. In addition, code operable to cause the computer system to perform any of the acts or operations described herein may be stored in the memory 810. The memory 810 may be a random-access memory, read-only memory, programmable memory, hard disk drive or any other type of memory or storage device.

The computer system 800 may include a display 830, such as a liquid crystal display (LCD), a cathode ray tube (CRT), or any other display suitable for conveying information. The display 830 may act as an interface for the user to see the functioning of the processor 805, or specifically as an interface with the software stored in the memory 810 or in the drive unit 815.

Additionally, the computer system 800 may include an input device 825, such as a keyboard or mouse, configured to allow a user to interact with any of the components of system 800.

The computer system 800 may also include a disk or optical drive unit 815. The disk drive unit 815 may include a computer-readable medium 840 in which one or more sets of instructions 845, e.g. software, can be embedded. Further, the instructions 845 may perform one or more of the operations as described herein. The instructions 845 may reside completely, or at least partially, within the memory 810 and/or within the processor 805 during execution by the computer system 800. The memory 810 and the processor 805 also may include computer-readable media as discussed above.

The computer system 800 may include a communication interface 835 that enables communications via a network 850. The network 850 may include wired networks, wireless networks, or combinations thereof. The communication interface 835 network may enable communications via any number of communication standards, such as 802.11, 802.17, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

As shown above, the system serving advertisements and interfaces that convey additional information related to the advertisement. For example, the system generates browser code operable by a browser to cause the browser to display a web page of information that includes an advertisement. The advertisement may include a graphical indicator that indicates that the advertisement is associated with an interface that conveys additional information associated with the advertisement. The browser code is the operable to cause the browser to detect a selection of the graphical indicator, and display the interface along with the information displayed on the web page in response to the selection of the graphical indicator. The advertisement and the additional information conveyed via the interface are submitted by an advertiser during an advertisement submission time.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

I claim:

1. A method for serving an advertisement in a networked system, the method comprising:
generating, by an advertisement server, browser code operable by a browser to cause the browser to perform acts of:
displaying a web page of information that includes an advertisement, wherein the displayed advertisement includes a graphical indicator that indicates that the advertisement is associated with an interface for conveying additional information associated with the advertisement, wherein the advertisement and the additional information are submitted during an advertisement submission time,
detecting a selection of the graphical indicator, and
displaying the interface along with the information displayed on the web page in response to the selection of the graphical indicator.

2. The method according to claim 1, wherein the selection occurs in response to a user action of the group of actions consisting of: a device click at the graphical indicator, and cursor movement over the advertisement.

3. The method according to claim 1, wherein the interface displays at least one input field for entering information.

4. The method according to claim 3, wherein the browser code is operable to process data specified via the input field and display a result within the interface.

5. The method according to claim 1, wherein the interface conveys audio information.

6. A method for generating an advertisement in a networked system, the method comprising:
communicating, by an advertisement server, a web page interface that enables the specification of a browser communicated advertisement, wherein the web page includes at least one input field that enables the selection of a customizable interface template;
receiving customization information associated with the customizable interface template;
associating the customized interface template and the customization information with the advertisement; and
communicating browser code operable to display the advertisement and the customized interface template as customized by the customization information to a browser, wherein the customized interface template as customized by the customization information is selectively displayed on the browser in response to a user selection of the advertisement.

7. The method according to claim 6, wherein the customization information defines a label on an input field of the customizable interface template.

8. The method according to claim 6, wherein the customization information defines a graphic image of the customizable interface template.

9. The method according to claim 6, wherein the customization information defines a sound of the customizable interface template.

10. A system for serving an advertisement in a networked system comprising:
an advertisement server that generates browser code operable by a browser to cause the browser to:
display a web page of information that includes an advertisement, wherein the displayed advertisement includes a graphical indicator that indicates that the advertisement is associated with an interface for conveying additional information associated with the advertisement, wherein the advertisement and the additional information are submitted during an advertisement submission time,
detect a selection of the graphical indicator, and
display the interface along with the information displayed on the web page in response to the selection of the graphical indicator.

11. The system according to claim 10, wherein the selection occurs in response to a user action of the group of actions consisting of: a device click at the graphical indicator, and cursor movement over the advertisement.

12. The system according to claim 10, wherein the interface displays at least one input field for entering information.

13. The system according to claim 13, wherein the browser code is operable to process data specified via the input field and display a result within the interface.

14. The system according to claim 10, wherein the interface conveys audio information.

15. A system for generating an advertisement in a networked system comprising:
an advertisement server configured to communicate a web page interface that enables the specification of a browser-communicated advertisement, wherein the web page includes at least one input field that enables the selection of a customizable interface template;
the advertisement server is further configured to receive customization information associated with the customizable interface template, associate the customized interface template and the customization information with the advertisement; and communicate browser code operable to display the advertisement and the customized interface template as customized by the customization information to a browser, wherein the customized interface template as customized by the customization information is selectively displayed on the browser in response to a user selection of the advertisement.

16. A machine-readable storage medium having stored thereon a computer program comprising at least one code section for serving an advertisement in a networked system, the at least one code section being executable by a machine for causing the machine to perform acts of:
generating browser code operable by a browser to cause the browser to perform acts of:
displaying a web page of information that includes an advertisement, wherein the displayed advertisement includes a graphical indicator that indicates that the advertisement is associated with an interface for conveying additional information associated with the advertisement, wherein the advertisement and the additional information are submitted during an advertisement submission time,
detecting a selection of the graphical indicator, and
displaying the interface along with the information displayed on the web page in response to the selection of the graphical indicator.

17. The machine-readable storage according to claim 16, wherein the selection occurs in response to a user action of the group of actions consisting of: a device click at the graphical indicator, and cursor movement over the advertisement.

18. The machine-readable storage according to claim 16, wherein the interface displays at least one input field for entering information.

19. The machine-readable storage according to claim 18, wherein the browser code is operable to process data specified via the input field and display a result within the interface.

20. The machine-readable storage according to claim 16, wherein the interface conveys audio information.

21. A machine-readable storage medium having stored thereon a computer program comprising at least one code section for generating an advertisement in a networked system, the at least one code section being executable by a machine for causing the machine to perform acts of:
communicating a web page interface that enables the specification of a browser communicated advertisement, wherein the web page includes at least one input field that enables the selection of a customizable interface template;
receiving customization information associated with the customizable interface template;
associating the customized interface template and the customization information with the advertisement; and
communicating browser code operable to display the advertisement and the customized interface template as customized by the customization information to a browser, wherein the customized interface template as customized by the customization information is selectively displayed on the browser in response to a user selection of the advertisement.
